(19) United States
(12) Patent Application Publication
(10) Pub. No.: US 2008/0178917 A1
(43) Pub. Date: Jul. 31, 2008

(54) SUBSTRATE PROCESSING APPARATUS AND SUBSTRATE PROCESSING METHOD

(76) Inventors: Masahiro Miyagi, Kyoto (JP); Masanobu SATO, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/015,880

(22) Filed: Jan. 17, 2008

(30) Foreign Application Priority Data
Jan. 31, 2007 (JP) 2007-020964

(51) Int. Cl. B08B 3/04

(52) U.S. Cl. 134/57 R

(57) ABSTRACT

A substrate processing apparatus has an ejection part for ejecting conductive processing liquid toward a substrate in a state where the processing liquid flows continuously and constantly. A conductive liquid contact part is provided in the vicinity of an outlet in the ejection part, and is connected to a potential applying part. The substrate to be processed is charged by induction because of charging of a cup part surrounding the substrate. When the substrate is processed by applying the processing liquid onto the substrate, an electric potential is applied to the processing liquid through the liquid contact part at the start time of ejection of the processing liquid, to decrease an electric potential difference generated between the substrate and the processing liquid ejected onto the substrate. With this operation, it is possible to suppress damage to the substrate caused by electric discharge occurring between the processing liquid and the substrate.

### BACKGROUND OF THE INVENTION

1. Field of the Invention

The present invention relates to a technique for processing a substrate by applying processing liquid onto the substrate.

2. Description of the Background Art

In manufacturing process of semiconductor products, various processings have been conventionally performed on a semiconductor substrate (hereinafter, simply referred to as “substrate”) on which an insulating film such as an oxide film is formed, with using a substrate processing apparatus. For example, while a substrate is rotated around the central axis perpendicular to a main surface of the substrate, processing liquid is applied to the position of the central axis on the substrate in a columnar shape to perform uniform processing on the surface of the substrate (for example, Japanese Patent Application Laid-Open No. 2006-66815 refers to such a processing). At this time, processing liquid splashed from the rotating substrate is received by a cup part (also referred to as a splash guard) surrounding the substrate, thereby preventing the processing liquid from being splashed outside the apparatus. Such a cup part is normally formed of electrical insulation material such as fluorine resin or vinyl chloride resin, from the viewpoint of corrosion resistance against the processing liquid.

In the meantime, a process using pure water (e.g., cleaning process) is also performed in the substrate processing apparatus. In this process, frictional charging in a cup part with insulating properties is caused by pure water with high resistivity (specific resistance) which is splashed from a substrate, and then the main body of the substrate is charged by induction due to electric field generated by the cup part. When processing liquid with conductivity is applied to the substrate in the columnar shape in the above state, relatively large electric discharge (electric discharge through the insulating film) occurs between a top end portion of the columnar processing liquid and the main body of the substrate, to cause great damage to an area, where the discharge occurs, on the substrate. Occurrence of such electric discharge is not limited to an insulating film which comes to breakdown, but for example, in a case where a fine pattern is formed on a substrate, there is a possibility electric discharge through air occurs between the top end portion of the columnar processing liquid and a surface of the substrate in a narrow gap sandwiched between elements of the pattern and in this case, a portion of the pattern close to the gap may be damaged by influences of the electric discharge.

### SUMMARY OF THE INVENTION

The present invention is intended for a substrate processing apparatus for processing a substrate by applying processing liquid onto the substrate. It is an object of the present invention to suppress damage to the substrate caused by an electric discharge occurring between the processing liquid and the substrate when the processing liquid is applied onto the substrate.

The substrate processing apparatus according to the present invention comprises: an ejection part for ejecting conductive processing liquid toward a substrate in a state where the processing liquid flows continuously; and a potential applying part for decreasing an electric potential difference generated between the substrate and processing liquid ejected onto the substrate by applying an electric potential to the processing liquid at least at the start time of ejection of the processing liquid, the electric potential being applied to the processing liquid at one of a position in a container in which the processing liquid before ejection is stored, a position in a passage from the container to the ejection part and a position in the ejection part.

According to the present invention, it is possible to suppress damage to the substrate caused by an electric discharge occurring between the processing liquid and the substrate when the processing liquid is applied onto the substrate.

According to a preferred embodiment of the present invention, the potential applying part applies an electric potential, which makes the electric potential difference to 0, to the processing liquid at the start time of ejection. It is thereby possible to prevent damage from arising in the substrate when the processing liquid is applied onto the substrate.

According to another preferred embodiment of the present invention, a conductive liquid contact part is provided in the vicinity of an outlet in the ejection part, and the potential applying part applies an electric potential to the liquid contact part. It is thereby possible to accurately adjust the electric potential of the processing liquid ejected onto the substrate. In this case, more preferably, the ejection part ejects a plurality of kinds of processing liquid, and each of the plurality of kinds of processing liquid is ejected from the outlet. This makes it possible to easily apply an electric potential to each processing liquid in a substrate processing apparatus which is capable of ejecting the plurality of kinds of processing liquid.

According to an aspect of the present invention, the substrate processing apparatus further comprises a surface electrometer which measures an electric potential on a surface of the substrate in a noncontact manner, and in the apparatus, an electric potential which is applied to the processing liquid by the potential applying part at the start time of ejection is determined on the basis of a measured value of the surface electrometer at the time just before ejection of the processing liquid. Since the electric potential applied to the processing liquid is determined on the basis of the electric potential on the surface of the substrate at the time just before ejection of the processing liquid, it is possible to surely suppress the electric discharge occurring between the processing liquid and the substrate at the start time of ejection of the processing liquid.

According to another aspect of the present invention, the substrate processing apparatus further comprises a surface electrometer which measures an electric potential on a surface of the substrate in a noncontact manner, and in the apparatus, the ejection part sequentially ejects a plurality of kinds of processing liquid, and an electric potential which is applied to each processing liquid by the potential applying part at the start time of ejection of each processing liquid, is determined on the basis of a measured value of the surface electrometer at the time just before ejection of each processing liquid. This makes it possible to surely suppress the electric discharge occurring between the processing liquid and the substrate at the start time of ejection of each processing liquid in a substrate processing apparatus where the plurality of kinds of processing liquid are ejected sequentially.

The present invention is also intended for a substrate processing method of processing a substrate by applying processing liquid onto the substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a substrate processing apparatus;

FIG. 2 is a flowchart showing an operation flow for processing a substrate;

FIG. 3 is a view showing another example of the substrate processing apparatus;

FIG. 4 is a flowchart showing a part of an operation flow for processing a substrate;

FIG. 5 is a view for explaining another technique for applying an electric potential to processing liquid; and

FIG. 6 is a view for explaining still another technique for applying an electric potential to processing liquid.

### DESCRIPTION OF THE PREFERRED EMBODIMENTS

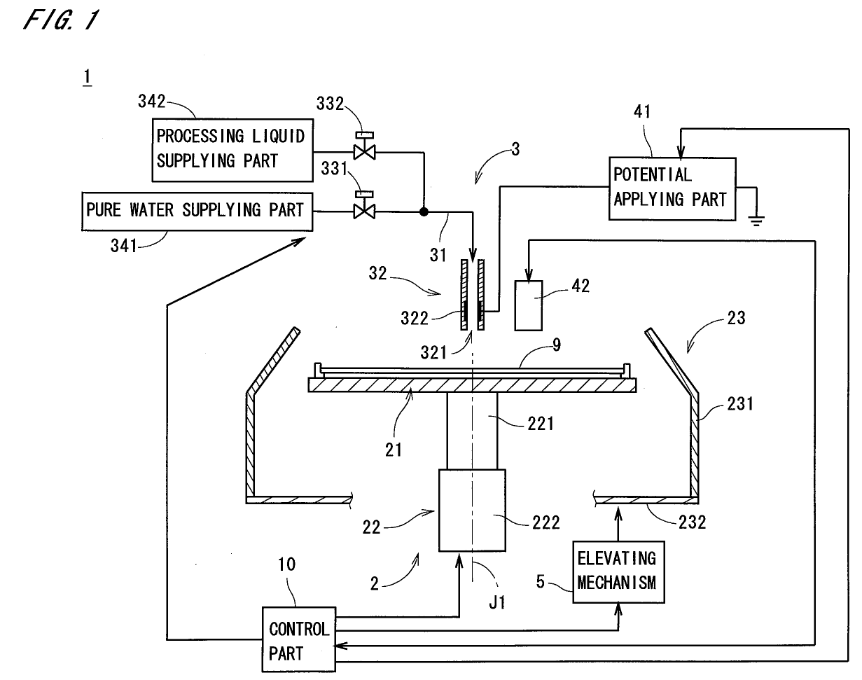

FIG. 1 is a view showing a construction of a substrate processing apparatus 1 in accordance with a preferred embodiment of the present invention. The substrate processing apparatus 1 is an apparatus of single wafer type for performing processing such as cleaning or etching by applying processing liquid such as pure water or diluted chemical solution onto a semiconductor substrate 9 (hereinafter, simply referred to as “substrate 9”) on which an insulating film is formed. In the preferred embodiment, processing using the processing liquid is performed on the substrate 9 on which an oxide film is formed. In the following discussion, conductive processing liquid is simply referred to as “processing liquid” for distinction from pure water with insulating properties.

As shown in FIG. 1, the substrate processing apparatus 1 has an approximately disk-shaped substrate holding part 21 for holding the disk-shaped substrate 9 horizontally, a holding part rotation mechanism 22 for rotating the substrate 9 together with the substrate holding part 21 around a central axis J1 perpendicular to the substrate 9, a cup part 23 which is formed of electrical insulation material such as fluorine resin or vinyl chloride resin and surrounds the substrate holding part 21, an elevating mechanism 5 which is a cylinder mechanism for moving the cup part 23 in the up and down direction (the vertical direction) in FIG. 1, a processing liquid applying part 3 for applying the conductive processing liquid and pure water with insulating properties onto an upper main surface (hereinafter, referred to as “upper surface”) of the substrate 9, a potential applying part 41 for applying an electric potential to the processing liquid in a later-discussed ejection part 32 in the processing liquid applying part 3, a surface electrometer 42 which is provided opposite to (i.e., faces) the upper surface of the substrate 9 and measures an electric potential on a surface (i.e., the upper surface) of the substrate 9 in a noncontact manner, and a control part 10 for controlling each of the constituent elements. Diluted hydrofluoric acid, hydrochloric acid, sulfuric acid, nitric acid, buffered hydrofluoric acid, aqueous ammonia, water becoming conductive where carbon dioxide (CO₂) or the like is dissolved into pure water, water including surface active agent, or the like, are used as the conductive processing liquid.

A shaft 221 of the holding part rotation mechanism 22 is provided on a lower surface of the substrate holding part 21 and the shaft 221 is connected to a motor 222. The substrate 9 is held by the substrate holding part 21 so that the center of the substrate 9 is located on the central axis J1 of the shaft 221. In the holding part rotation mechanism 22, the motor 222 is driven by control of the control part 10 to rotate the shaft 221, and the substrate 9 rotates around the central axis J1 together with the substrate holding part 21 and the shaft 221.

The cup part 23 has a side wall 231 which receives liquid splashed from the substrate 9 by surrounds the substrate holding part 21. A ring-shaped bottom part 232, which protrudes toward the central axis J1 and covers a lower space of the substrate holding part 21, is attached to a lower end portion of the side wall 231, and a drain outlet (not shown) for draining liquid applied onto the substrate 9 is provided in the bottom part

The processing liquid applying part 3 has the ejection part 32 which is a nozzle connected to a supply pipe 31 (which is formed of, for example, electrical insulation material such as fluorine resin) and the main body of the ejection part 32 is formed of electrical insulation material (e.g., ceramic, resin, or the like). The ejection part 32 is located on the central axis J1 and above the substrate 9. The supply pipe 31 is branched off into two pipes on a side which is opposite to the ejection part 32. One pipe is connected to a pure water supplying part 341, which is a supply source of pure water, with interposing a pure water valve 331 and the other is connected to a processing liquid supplying part 342, which is a supply source of the processing liquid, with interposing a processing liquid valve 332. In the processing liquid applying part 3, pure water or the processing liquid is applied onto the substrate 9 from the ejection part 32 by opening the pure water valve 331 or the processing liquid valve 332. Since a processing liquid tank (not shown) for storing the processing liquid in the processing liquid supplying part 342 is grounded, an electric potential of the processing liquid which is supplied from the processing liquid supplying part 342 to the processing liquid applying part 3 is a ground potential.

In the ejection part 32, a conductive liquid contact part 322 (shown by thick lines in FIG. 1) is provided in the vicinity of an outlet 321 which is opposite to the substrate 9, and the liquid contact part 322 is connected to the potential applying part 41. As discussed later, when the processing liquid is ejected from the ejection part 32, an electric potential is applied to the liquid contact part 322 by the potential applying part 41 and thereby, an electric potential of the processing liquid ejected from the outlet 321 is made approximately equal to that applied to the liquid contact part 322. The liquid contact part 322 is formed of, for example, glassy conductive carbon such as amorphous carbon or glassy carbon or conductive resin such as conductive PEEK (poly-ether-ether-ketone) or conductive PTFE (poly-tetra-fluoro-ethylene).

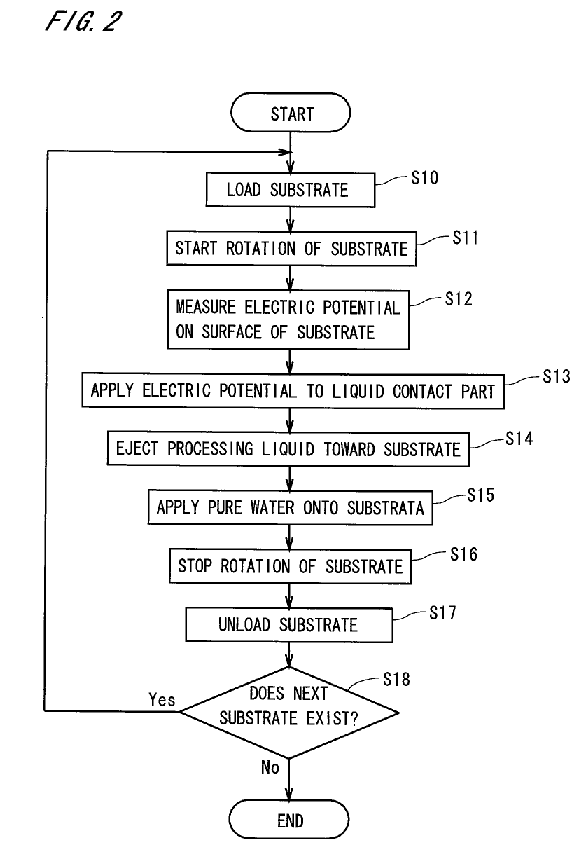

FIG. 2 is a flowchart showing an operation flow for processing the substrate 9 in the substrate processing apparatus 1. In the substrate processing apparatus 1 of FIG. 1, first, the substrate 9 is placed and held on the substrate holding part 21 by an external carrying apparatus (i.e., the substrate 9 is loaded) in a state where the cup part 23 is positioned below the substrate holding part 21 by the elevating mechanism 5 (Step S10). Subsequently, the cup part 23 moves up to put the substrate holding part 21 in the cup part 23 and the motor 222 of the holding part rotation mechanism 22 is driven by the control part 10 to start rotation of the substrate 9 (Step S11). Though the following processes using the processing liquid and pure water are normally performed in a state where the substrate 9 is rotated, rotation speed of the substrate 9 may be changed as necessary.

After rotation of the substrate 9 is started, the processing liquid is supplied to the ejection part 32 by opening the processing liquid valve 332 and the processing liquid is thereby ejected toward the central portion of the rotating substrate 9 from the ejection part 32 in a state where the processing liquid flows continuously and constantly (without pausing) in a rod shape (i.e., in a state of a columnar shape) (Step S14). Application of the processing liquid in the columnar shape is continued for a predetermined time period to achieve uniform processing of the substrate 9 using the processing liquid. Operations of Steps S12, S13 in FIG. 2 are omitted in a substrate processing operation performed on the first substrate 9.

After the processing liquid valve 332 is closed and application of the processing liquid onto the substrate 9 is finished, the pure water valve 331 is opened to supply pure water to the ejection part 32, and the pure water is applied onto the substrate 9 from the ejection part 32 and the upper surface of the substrate 9 is cleaned by the pure water (Step S15). At this time, an inner annular surface of the cup part 23 is frictionally charged (i.e., frictional charging is caused) by the pure water splashed from the substrate 9. After ejection of the pure water is stopped, the substrate 9 is further rotated for a predetermined time period to dry the substrate 9 and thereafter, rotation of the substrate 9 is stopped (Step S16). Then, the cup part 23 moves below the substrate holding part 21, and the substrate 9 is taken and conveyed out from the substrate holding part 21 by the external carrying apparatus (i.e., the substrate 9 is unloaded) (Step S17).

When it is confirmed the next (second) substrate 9 to be processed exists (Step S18), the substrate 9 is placed and held on the substrate holding part 21 (Step S10) and the cup part 23 moves up to put the substrate holding part 21 inside the cup part 23. At this time, since the inner annular surface of the cup part 23 is charged as discussed above, (a main body of) the substrate 9 held on the substrate holding part 21 is charge at (−3) kilovolt (KV) by induction, for example.

Subsequently, after rotation of the substrate 9 is started (Step S11), the surface electrometer 42 measures an electric potential on the upper surface of the substrate 9 in the vicinity of an ejection position of the processing liquid ejected from the ejection part 32 to obtain a measured value (the processing liquid has not been ejected yet) (Step S12) and the measured value is outputted to the control part 10. After completion of measurement by the surface electrometer 42, an electric potential is applied to the liquid contact part 322 by the potential applying part 41 (as discussed later, the electric potential is applied to the processing liquid ejected from the ejection part 32 and it is hereinafter referred to as “ejection potential”) (Step S13) and the processing liquid valve 332 is opened. With this operation, the processing liquid is ejected toward the central portion of the substrate 9 in the columnar shape from the ejection part 32 (Step S14) and the ejection potential is applied to the processing liquid ejected from the ejection part 32. At this time, the control part 10 determines (a value of) the ejection potential which is applied to the processing liquid by the potential applying part 41 at the start time of ejection of the processing liquid, on the basis of the measured value of the surface electrometer 42 at the time just before ejection of the processing liquid. Specifically, the ejection potential is an electric potential for making an electric potential difference generated between the substrate 9 and the processing liquid ejected onto the substrate 9 to 0 and thereby, it is (ideally) prevented that electric discharge occurs between the processing liquid and the main body of the charged substrate 9 at the start time of ejection of the processing liquid. In the potential applying part 41, since the ejection potential is continuously applied to the processing liquid while the processing liquid is ejected from the ejection part 32 after the start time of ejection of the processing liquid, it is prevented electric discharge occurs between the processing liquid and the substrate 9 during ejection of the processing liquid.

After application of the processing liquid in the columnar shape is finished, cleaning process of the substrate 9 using pure water is performed (Step S15). Then, rotation of the substrate 9 is stopped (Step S16) and the substrate 9 is taken and conveyed out from the substrate holding part 21 (Step S17).

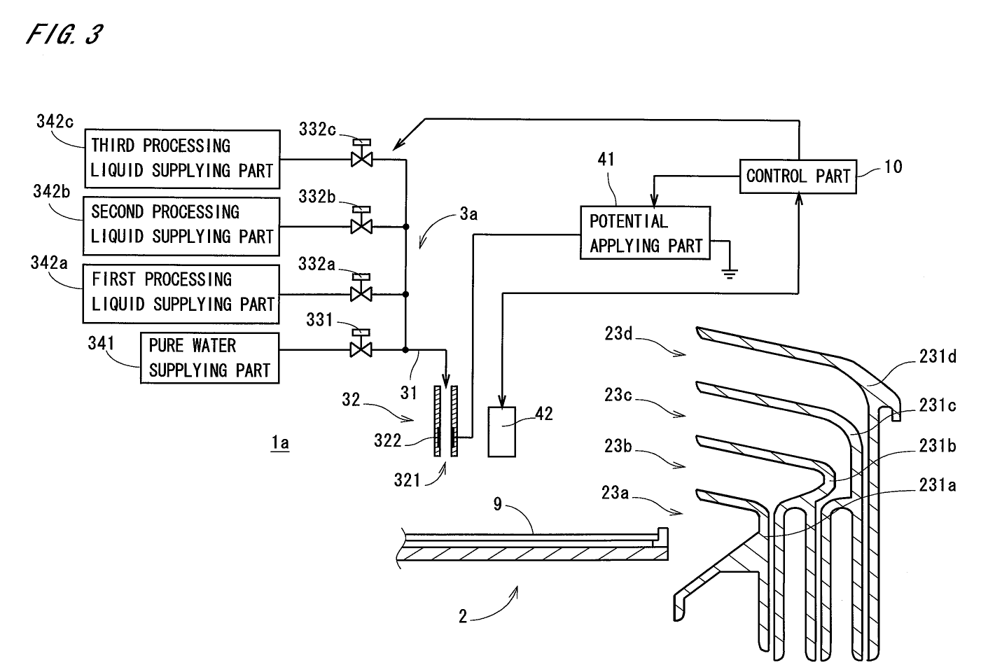

In the substrate processing apparatus 1, the above operations of Steps S10 to S17 are repeatedly performed on remaining substrates 9 to be processed, and the substrate processing operation is completed in the substrate processing apparatus 1 (Step S18). Though the operations of Steps S12, S13 are omitted in the first substrate 9 in this operation example, the operations of Steps S12, S13 may be naturally performed on the first substrate 9 and in this case, since the same process is performed on all the substrates 9 to be processed, it is possible to simplify control in the control part 10 (the same as in a substrate processing apparatus 1a of FIG. 3 which is discussed later).

As discussed above, in a case where the substrate 9 is charged by induction because of charging (electric charge) of the cup part 23 generated in splashing of pure water in cleaning of the substrate 9 using the pure water, if the processing liquid with the ground potential is applied onto the substrate 9, relatively large electric discharge between a top end portion of the columnar processing liquid and the main body of the substrate 9 occurs on a narrow area on the upper surface of the substrate 9, to cause great damage to the area on the substrate 9.

On the other hand, in the substrate processing apparatus 1, since the ejection potential is applied to the processing liquid at the time of ejection of the processing liquid, the electric potential difference generated between the substrate 9 and the processing liquid ejected onto the substrate 9 is decreased (ideally, the electric potential difference is made to 0). With this operation, it is possible to suppress the electric discharge occurring between the processing liquid and the substrate 9 when the processing liquid is applied onto the substrate 9, to thereby suppress damage to the substrate 9 caused by the electric discharge occurring between the processing liquid and the substrate 9. Since the electric potential applied to the processing liquid is determined on the basis of the electric potential on the surface of the substrate 9 at the time just before ejection of the processing liquid, the electric potential being acquired by the surface electrometer 42, it is possible to surely suppress the electric discharge occurring between the processing liquid and the substrate 9 at the start time of ejection of the processing liquid.

In the substrate processing apparatus 1, the ejection potential may be applied to the processing liquid only at the start time of ejection of the processing liquid from the ejection part 32 and in this case, application of the ejection potential to the processing liquid is stopped after the processing liquid with the ejection potential reaches the substrate 9. At this time, since the rotation speed of the substrate 9 is relatively low, the processing liquid which reaches the substrate 9 spreads like a film (i.e., a film of the processing liquid is formed on the substrate 9). Then, the processing liquid which comes to have the ground potential by stop of application of the ejection potential to the processing liquid, is applied onto the substrate 9, and the film of the processing liquid formed on the substrate 9 is grounded. As a result, small (slight) electric discharge occurs between the main body of the substrate 9 and the whole film of the processing liquid formed on the substrate 9 (i.e., the small electric discharge occurs in the whole upper surface of the substrate 9) and an electric potential of the main body of the substrate 9 nearly becomes the ground potential. In this manner, even in the case where the ejection potential is applied to the processing liquid only at the start time of ejection of the processing liquid, occurrence of electric discharge concentrating on the narrow area on the substrate 9 is prevented (i.e., small electric discharge occurs on a large area (deconcentrated areas) on the upper surface), to suppress damage to the substrate 9 caused by large electric discharge occurring between the processing liquid and the substrate 9. As discussed above, in the substrate processing apparatus 1, the electric potential which decreases the electric potential difference generated between the substrate 9 and the processing liquid ejected onto the substrate 9, is applied to the processing liquid at least at the start time of ejection of the processing liquid, to thereby suppress damage to the substrate 9 caused by the electric discharge occurring between the processing liquid and the substrate 9 (the same as in the substrate processing apparatus 1a of FIG. 3 which is discussed later).

FIG. 3 is a view showing a part of a construction of a substrate processing apparatus 1a having a plurality of cup parts 23a, 23b, 23c, 23d and only shows a right side of a cross section of side walls 231a to 231d of the plurality of concentric cup parts 23a to 23d, the cross section being perpendicular to a substrate 9. In the substrate processing apparatus 1a of FIG. 3, a supply pipe 31 connected to an ejection part 32 is branched off into four pipes on a side which is opposite to the ejection part 32, and the four pipes are respectively connected to a pure water supplying part 341 which is a supply source of pure water and first to third processing liquid supplying parts 342a to 342c which are supply sources of first to third processing liquid, with interposing valves 331, 332a to 332c. As discussed later, the plurality of cup parts 23a to 23d move up and down as a unit, and a position of the plurality of cup parts 23a to 23d relative to the substrate 9 is changed in accordance with a kind of liquid (pure water or processing liquid) ejected from a processing liquid applying part 3a. Similarly to the substrate processing apparatus 1 of FIG. 1, a conductive liquid contact part 322 (shown by thick lines in FIG. 3) is provided in the vicinity of an outlet 321 in the ejection part 32 in the substrate processing apparatus 1a and an electric potential is applied to the liquid contact part 322 by a potential applying part 41.

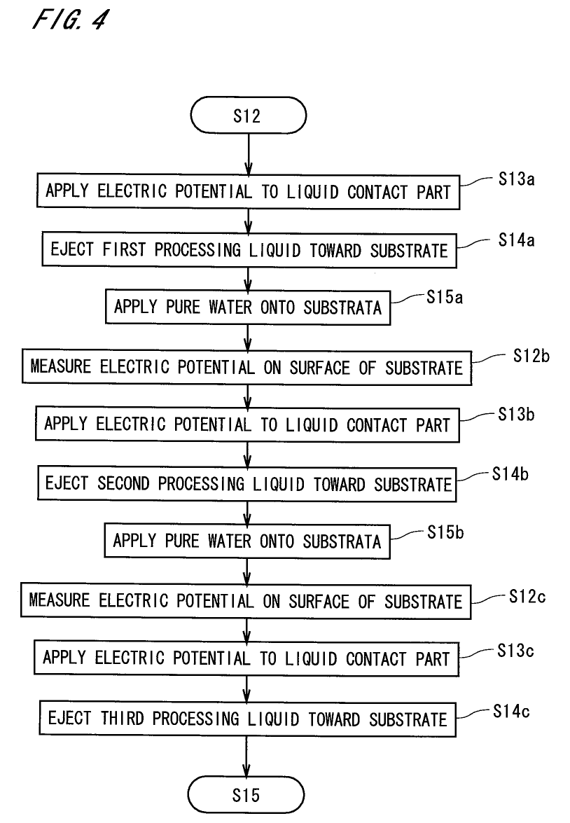

FIG. 4 is a flowchart showing a part of an operation flow for processing the substrate 9 in the substrate processing apparatus 1a and shows processes performed instead of Steps S13, S14 of FIG. 2. Following discussion will be made on a basic operation in the substrate processing apparatus 1a with reference to FIGS. 2 and 4.

In the substrate processing apparatus 1a of FIG. 3, after the substrate 9 is loaded (FIG. 2: Step S10), the plurality of cup parts 23a to 23d move and the substrate 9 is disposed in a position between a top end of the side wall 231a of an innermost cup part 23a and a top end of the side wall 231d which is located outside the side wall 231a. After rotation of the substrate 9 is started (Step S11), a surface electrometer 42 measures an electric potential on the upper surface of the substrate 9 in the vicinity of an ejection position of the processing liquid ejected from the ejection part 32 to obtain a measured value (the processing liquid has not been ejected yet) (Step S12). Subsequently, an ejection potential based on the measured value of the surface electrometer 42 is applied to the liquid contact part 322 (FIG. 4: Step S13a), and the first processing liquid with the ejection potential is ejected toward the central portion of the substrate 9 in the columnar shape from the ejection part 32 (Step S14a). At this time, the first processing liquid splashed from the substrate 9 is received by an outer annular surface of the side wall 231a and an inner annular surface of the side wall 231b.

After application of the first processing liquid onto the substrate 9 is finished, the substrate 9 is disposed in a position below the top end of the innermost side wall 231a (i.e., the position is shown in FIG. 3 and hereinafter, referred to as “pure water applying position”), and pure water is applied onto the substrate 9 from the ejection part 32 to clean the upper surface of the substrate 9 by the pure water (Step S15a). After cleaning using the pure water is finished, the substrate 9 is rotated at high speed for a while to dry the substrate 9. Subsequently, the substrate 9 is disposed in a position between the top end of the side wall 231b and a top end of the side wall 231c which is located outside the side wall 231b and an electric potential on the surface of the substrate 9 is measured to obtain a measured value (Step S12b). Then, an ejection potential based on the immediate measured value of the surface electrometer 42 is applied to the liquid contact part 322 (Step S13b), and the second processing liquid with the ejection potential is ejected toward the central portion of the substrate 9 in the columnar shape from the ejection part 32 (Step S14b). At this time, the second processing liquid splashed from the substrate 9 is received by an outer annular surface of the side wall 231b and an inner annular surface of the side wall 231c.

After application of the second processing liquid onto the substrate 9 is finished, the substrate 9 is disposed in the pure water applying position and the upper surface of the substrate 9 is cleaned by the pure water (Step S15b). After cleaning using the pure water is finished, the substrate 9 is rotated at high speed for a while to dry the substrate 9. Subsequently, the substrate 9 is disposed in a position between the top end of the side wall 231c and a top end of the side wall 231d (outermost side wall) which is located outside the side wall 231c and an electric potential on the surface of the substrate 9 is measured to obtain a measured value (Step S12c). Then, an ejection potential based on the immediate measured value of the surface electrometer 42 is applied to the liquid contact part 322 (Step S13c), and the third processing liquid with the ejection potential is ejected toward the central portion of the substrate 9 in the columnar shape from the ejection part 32 (Step S14c). At this time, the third processing liquid splashed from the substrate 9 is received by an outer annular surface of the side wall 231c and an inner annular surface of the side wall 231d.

After application of the third processing liquid is finished, the substrate 9 is disposed in the pure water applying position and pure water is applied onto the substrate 9 from the ejection part 32 to clean the upper surface of the substrate 9 by the pure water (FIG. 2: Step S15). After ejection of the pure water is finished, the substrate 9 is rotated at high speed for a while to dry the substrate 9 and thereafter, rotation of the substrate 9 is stopped (Step S16). The substrate 9 is unloaded (Step S17) and the next substrate 9 to be processed is loaded in the substrate processing apparatus 1a (Steps S18, S10).

In the substrate processing apparatus 1a, when the processes of Steps S15a, S15b, S15 are performed on the substrate 9 before each of the second and subsequent substrates 9, the inner annular surface of the inner side wall 231a is frictionally charged by the pure water splashed from the substrate 9. Thus, each of the second and subsequent substrates 9 held on the substrate holding part 21 is charged by induction. When the first, second, or third processing liquid is ejected onto the substrate 9 in each of Steps S14a to S14c of FIG. 4, an ejection potential which is applied to the processing liquid by the potential applying part 41 at the start time of ejection, is determined as an electric potential for making an electric potential difference generated between the substrate 9 and the processing liquid ejected onto the substrate 9 to 0, on the basis of a measured value of the surface electrometer 42 at the time just before ejection of the processing liquid in each of Steps S12, S12b, S12c.

A relative position between the substrate 9 and the side wall 231a of the charged cup part 23a is different among ejection of the first processing liquid in Step S14a of FIG. 4, ejection of the second processing liquid in Step S14b, and ejection of the third processing liquid in Step S14c, and therefore, the electric potential on the surface of the substrate 9 caused by induction charging is different among them. If a constant electric potential is applied to the plurality of kinds of processing liquid, in application of each processing liquid there is a possibility that the electric potential difference generated between the substrate 9 and the processing liquid ejected onto the substrate 9 is not decreased, depending on a value of the above electric potential.

On the other hand, in the substrate processing apparatus 1a of FIG. 3, when the plurality of kinds of processing liquid are sequentially ejected from the ejection part 32, the electric potential applied to each processing liquid is determined on the basis of the measured value of the surface electrometer 42 at the time just before ejection of the processing liquid. It is therefore possible to surely suppress electric discharge occurring between the processing liquid and the substrate 9 at the start time of ejection of the processing liquid, even in the case where the electric potential on the surface of the substrate 9 changes according to the relative position between the charged side wall 231a and the substrate 9. As a result, it is possible to suppress damage to the substrate 9 caused by the electric discharge occurring between the processing liquid and the substrate 9. In the ejection part 32, since the liquid contact part 322 is provided in the vicinity of the outlet 321 and each of the plurality of kinds of processing liquid is ejected from the same outlet 321, it is possible to easily apply an electric potential to each processing liquid in the substrate processing apparatus 1a which is capable of ejecting the plurality of kinds of processing liquid.

Even in the case that a constant electric potential is applied to the plurality of kinds of processing liquid in the substrate processing apparatus 1a, since an amount of the constant electric potential applied to the liquid contact part 322 is determined so that, in ejection of the first to third processing liquid to the substrate 9, for example, the sum of the electric potential differences generated between the substrate 9 and the processing liquid ejected onto the substrate 9 is minimum, or, the maximum value of the electric potential differences generated between the substrate 9 and the processing liquid is smaller than a withstand voltage (breakdown voltage) of the insulating film formed on the substrate 9, it is possible to suppress damage to the substrate 9 caused by the electric discharge occurring between the processing liquid and the substrate 9 and in this case, it is also possible to simplify control process in the control part 10.

Though the preferred embodiment of the present invention has been discussed above, the present invention is not limited to the above-discussed preferred embodiment, but allows various variations.

In the substrate processing apparatuses 1, 1a, in the case that the substrate 9 is charged by induction because of charging of the cup parts 23, 23a generated in splashing of pure water in cleaning of the substrate 9 using the pure water, the electric potential is applied to the processing liquid ejected toward the substrate 9 and thereby, damage to the substrate 9 caused by the electric discharge occurring between the processing liquid and the substrate 9 is suppressed. However, in the case that cleaning of the substrate 9 using pure water is omitted, if the processing liquid is ejected onto the substrate 9 without application of an electric potential by the potential applying part 41 in a case where the substrate 9 to be processed is charged by an immediate process performed outside the substrate processing apparatus, a case where the processing liquid is charged (when the plurality of kinds of processing liquid are used, it is considered the plurality of kinds of processing liquid are charged to different electric potentials) or the like, damage to the substrate 9 caused by the electric discharge occurring between the processing liquid and the substrate 9 becomes greater. Therefore, in a case where the electric potential difference is generated between the processing liquid and the substrate 9, it is required to use the above technique which is capable of suppressing damage to the substrate 9 caused by the electric discharge occurring between the processing liquid and the substrate 9.

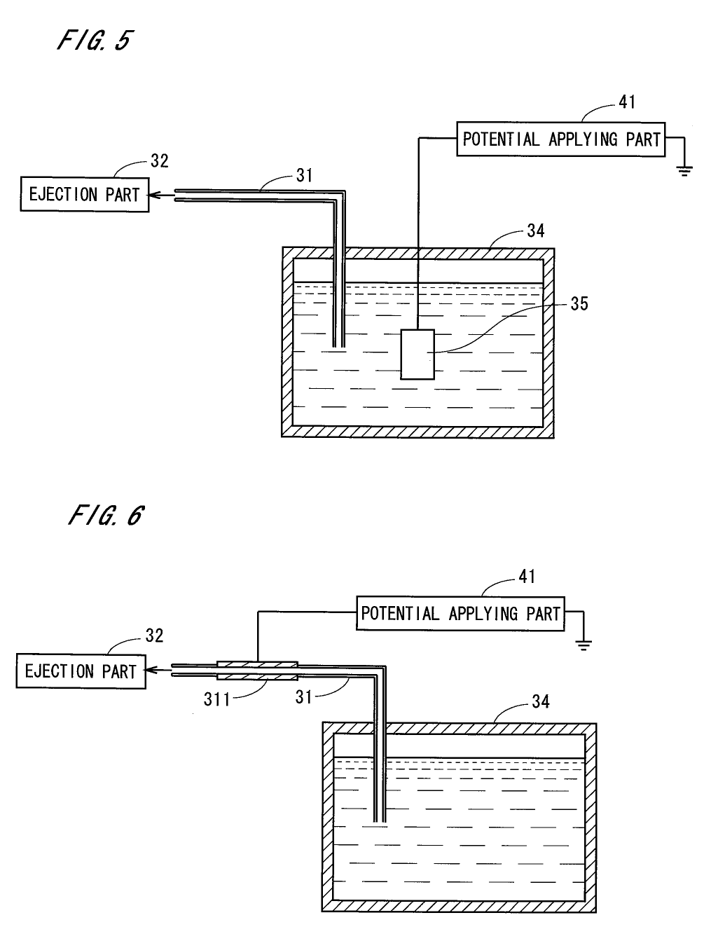

In the substrate processing apparatuses 1, 1a, though the electric potential can be applied to the processing liquid by providing the liquid contact part 322 in the ejection part 32, there may be a case where as shown in FIG. 5, a conductive member 35 (which is formed of e.g., conductive carbon or conductive resin, and this is applied to a later-discussed conductive part 311) is dipped into processing liquid before ejection stored in a container 34 (i.e., processing liquid tank) which is formed of electrical insulation material, or as shown in FIG. 6, the conductive part 311 is formed in a part of a supply pipe 31 which is a passage from the container 34 to an ejection part 32, the conductive member 35 or the conductive part 311 is connected to a potential applying part 41 and thereby, an electric potential is applied to the processing liquid ejected onto the substrate 9. Also, a conductive liquid contact part is provided at a position away from the outlet 321 in the ejection part 32 and an electric potential may be applied to the processing liquid.

As discussed above, application of electric potential to the processing liquid ejected onto the substrate 9 is achieved by applying an electric potential to a member contacting the processing liquid at one of a position in the container 34 in which the processing liquid before ejection is stored, a position in the passage from the container 34 to the ejection part 32 and a position in the ejection part 32. However, depending on design of the substrate processing apparatus, since there is a case where a voltage drop occurs in the passage from the container 34 to the ejection part 32 or in the ejection part 32, it is preferable the conductive liquid contact part 322 is provided in the vicinity of the outlet 321 in the ejection part 32 and an electric potential is applied to the liquid contact part 322 by the potential applying part 41, for accurately adjusting the electric potential of the processing liquid ejected onto the substrate 9.

In a case where the insulating film is formed on the surface of the substrate 9 to be processed like in the above preferred embodiment, there may be a case where the surface electrometer 42 is omitted from the substrate processing apparatus, and the ejection potential which is applied to the processing liquid by the potential applying part 41 at the start time of ejection is made to a fixed potential for making the electric potential difference generated between the substrate 9 and the processing liquid ejected onto the substrate 9, to be equal to or smaller than the withstand voltage of the insulating film.

Also in a case where a fine pattern is formed on a substrate with using electrical insulation material as discussed above, except the case that a uniform insulating film is formed on the surface of the substrate 9, there is a possibility electric discharge through air occurs between a top end portion of processing liquid and a surface of the substrate in a narrow gap sandwiched between elements of the pattern and in this case, a portion of the pattern close to the gap may be damaged by influences of the electric discharge. Therefore, in order to prevent damage (such as damage to the insulating film or the pattern) from arising in the substrate when the processing liquid is applied onto the substrate, it is preferable the ejection potential which is applied to the processing liquid by the potential applying part 41 at the start time of ejection of the processing liquid is determined as an electric potential for making an electric potential difference generated between the substrate and the processing liquid ejected onto the substrate, to 0.

Although the processing liquid is ejected from the ejection part 32 in the columnar shape in the above preferred embodiment, the processing liquid may be ejected in a curtain shape so far as it is ejected from the ejection part 32 in a state where the processing liquid flows continuously.

The substrate processing apparatuses 1, 1a may be used for processing various substrates such as a printed circuit board or a glass substrate for a flat panel display, as well as a semiconductor substrate.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2007-20964 filed in the Japan Patent Office on Jan. 31, 2007, the entire disclosure of which is incorporated herein by reference.

What is claimed is:

1. A substrate processing apparatus for processing a substrate by applying processing liquid onto said substrate, comprising:
an ejection part for ejecting conductive processing liquid toward a substrate in a state where said processing liquid flows continuously; and
a potential applying part for decreasing an electric potential difference generated between said substrate and processing liquid ejected onto said substrate by applying an electric potential to said processing liquid at least at the start time of ejection of said processing liquid, said electric potential being applied to said processing liquid at one of a position in a container in which said processing liquid before ejection is stored, a position in a passage from said container to said ejection part and a position in said ejection part.

2. The substrate processing apparatus according to claim 1, wherein
said potential applying part continuously applies an electric potential to said processing liquid while said processing liquid is ejected from said ejection part.

3. The substrate processing apparatus according to claim 1, wherein
said potential applying part applies an electric potential, which makes said electric potential difference to 0, to said processing liquid at said start time of ejection.

4. The substrate processing apparatus according to claim 1, wherein
a conductive liquid contact part is provided in the vicinity of an outlet in said ejection part, and
said potential applying part applies an electric potential to said liquid contact part.

5. The substrate processing apparatus according to claim 4, wherein
said ejection part ejects a plurality of kinds of processing liquid including said processing liquid, and
each of said plurality of kinds of processing liquid is ejected from said outlet.

6. The substrate processing apparatus according to claim 1, further comprising
a surface electrometer which measures an electric potential on a surface of said substrate in a noncontact manner, wherein
an electric potential which is applied to said processing liquid by said potential applying part at said start time of ejection is determined on the basis of a measured value of said surface electrometer at the time just before ejection of said processing liquid.

7. The substrate processing apparatus according to claim 2, further comprising
a surface electrometer which measures an electric potential on a surface of said substrate in a noncontact manner, wherein
an electric potential which is applied to said processing liquid by said potential applying part at said start time of ejection is determined on the basis of a measured value of said surface electrometer at the time just before ejection of said processing liquid.

8. The substrate processing apparatus according to claim 3, further comprising
a surface electrometer which measures an electric potential on a surface of said substrate in a noncontact manner, wherein
an electric potential which is applied to said processing liquid by said potential applying part at said start time of ejection is determined on the basis of a measured value of said surface electrometer at the time just before ejection of said processing liquid.

9. The substrate processing apparatus according to claim 4, further comprising
a surface electrometer which measures an electric potential on a surface of said substrate in a noncontact manner, wherein
an electric potential which is applied to said processing liquid by said potential applying part at said start time of ejection is determined on the basis of a measured value of said surface electrometer at the time just before ejection of said processing liquid.

10. The substrate processing apparatus according to claim 5, further comprising
a surface electrometer which measures an electric potential on a surface of said substrate in a noncontact manner, wherein
an electric potential which is applied to said processing liquid by said potential applying part at said start time of ejection is determined on the basis of a measured value of said surface electrometer at the time just before ejection of said processing liquid.

11. The substrate processing apparatus according to claim 1, further comprising
a surface electrometer which measures an electric potential on a surface of said substrate in a noncontact manner, wherein
said ejection part sequentially ejects a plurality of kinds of processing liquid including said processing liquid, and
an electric potential which is applied to each processing liquid by said potential applying part at the start time of ejection of said each processing liquid, is determined on the basis of a measured value of said surface electrometer at the time just before ejection of said each processing liquid.

12. The substrate processing apparatus according to claim 2, further comprising
a surface electrometer which measures an electric potential on a surface of said substrate in a noncontact manner, wherein
said ejection part sequentially ejects a plurality of kinds of processing liquid including said processing liquid, and
an electric potential which is applied to each processing liquid by said potential applying part at the start time of ejection of said each processing liquid, is determined on the basis of a measured value of said surface electrometer at the time just before ejection of said each processing liquid.

13. The substrate processing apparatus according to claim 3, further comprising
a surface electrometer which measures an electric potential on a surface of said substrate in a noncontact manner, wherein
said ejection part sequentially ejects a plurality of kinds of processing liquid including said processing liquid, and
an electric potential which is applied to each processing liquid by said potential applying part at the start time of ejection of said each processing liquid, is determined on the basis of a measured value of said surface electrometer at the time just before ejection of said each processing liquid.

14. The substrate processing apparatus according to claim 4, further comprising
a surface electrometer which measures an electric potential on a surface of said substrate in a noncontact manner, wherein
said ejection part sequentially ejects a plurality of kinds of processing liquid including said processing liquid, and
an electric potential which is applied to each processing liquid by said potential applying part at the start time of ejection of said each processing liquid, is determined on the basis of a measured value of said surface electrometer at the time just before ejection of said each processing liquid.

15. A substrate processing method of processing a substrate by applying processing liquid onto said substrate, comprising the steps of:
a) ejecting conductive processing liquid toward a substrate from an ejection part in a state where said processing liquid flows continuously; and
b) decreasing an electric potential difference generated between said substrate and processing liquid ejected onto said substrate by applying an electric potential to said processing liquid at least at the start time of ejection of said processing liquid, said electric potential being applied to said processing liquid at one of a position in a container in which said processing liquid before ejection is stored, a position in a passage from said container to said ejection part and a position in said ejection part.

16. The substrate processing method according to claim 15, wherein
an electric potential is continuously applied to said processing liquid while said processing liquid is ejected from said ejection part in said step b).

17. The substrate processing method according to claim 15, wherein
an electric potential for making said electric potential difference to 0 is applied to said processing liquid at said start time of ejection in said step b).

18. The substrate processing method according to claim 15, wherein
a conductive liquid contact part is provided in the vicinity of an outlet in said ejection part, and
an electric potential is applied to said liquid contact part in said step b).

19. The substrate processing method according to claim 18, wherein
said ejection part ejects a plurality of kinds of processing liquid including said processing liquid, and
each of said plurality of kinds of processing liquid is ejected from said outlet.

20. The substrate processing method according to claim 15, further comprising the step of
c) measuring an electric potential on a surface of said substrate at the time just before ejection of said processing liquid, wherein
an electric potential which is applied to said processing liquid at said start time of ejection is determined on the basis of a measured value in said step c).

21. The substrate processing method according to claim 15, wherein
said ejection part sequentially ejects a plurality of kinds of processing liquid including said processing liquid,
an electric potential on a surface of said substrate at the time just before ejection of each processing liquid is measured to obtain a measured value, and
an electric potential which is applied to said each processing liquid at the start time of ejection of said each processing liquid is determined on the basis of said measured value.
